(19) United States
(12) Patent Application Publication
(10) Pub. No.: US 2022/0230165 A1
(43) Pub. Date: Jul. 21, 2022

(54) BLOCKCHAIN-BASED OUTLET SITE SELECTION METHOD AND APPARATUS, DEVICE AND STORAGE MEDIUM

(71) Applicant: Beijing Baidu Netcom Science Technology Co., Ltd., Beijing (CN)

(72) Inventor: BO JING, Beijing (CN)

(21) Appl. No.: 17/715,258

(22) Filed: Apr. 7, 2022

(30) Foreign Application Priority Data
Jun. 29, 2021 (CN) 202110729981.3

(51) Int. Cl. G06Q 20/38; G06Q 20/06

(52) U.S. Cl. CPC G06Q 20/389; G06Q 20/06

(57) ABSTRACT

A blockchain-based outlet site selection method, apparatus, device and storage medium can be provided. For example, using such exemplary method, apparatus, device and storage medium, in response to an outlet site selection request of a task demander, it is possible to determine a target data source and a target feature dimension associated with the target data source; acquire, from the target data source, target feature data of candidate grids in a target region according to the target feature dimension and target region information in the outlet site selection request; select a target grid from the candidate grids according to the target feature data of the candidate grids; and control the task demander to pay a token to the target data source based on a smart contract according to usage attribute information of the target feature data.

### CROSS-REFERENCE TO RELATED APPLICATION(S)

This application claims priority to Chinese Patent Application No. 202110729981.3 filed Jun. 29, 2021, the disclosure of which is incorporated herein by reference in its entirety.

### FIELD OF THE DISCLOSURE

The present disclosure relates to the field of computer technology and, in particular, to the field of blockchain technology, for example, a blockchain-based outlet site selection method and apparatus, a device and a storage medium, and is applicable to cloud computing and cloud services.

### BACKGROUND INFORMATION

As forward positions of business, business outlets play an important role in market share. In terms of banking, for example, banking outlets are not only related to the reputation and profits of banks, but are also related to the vital interest of customers.

How to select a site suitable for opening an outlet, that is, how to select an outlet site is greatly important.

### SUMMARY OF EXEMPLARY EMBODIMENT(S)

Exemplary embodiments of the present disclosure provide a blockchain-based outlet site selection method and apparatus, a device and a storage medium.

According to an exemplary embodiment of the present disclosure, a blockchain-based outlet site selection method can be provided. The exemplary method the exemplary steps and/or procedures which are described herein.

For example, in response to an outlet site selection request of a task demander, a target data source and a target feature dimension associated with the target data source can be determined.

Target feature data of candidate grids in a target region are acquired from the target data source according to the target feature dimension and target region information in the outlet site selection request.

A target grid can be selected from the candidate grids according to the target feature data of the candidate grids.

The task demander can be controlled to pay a token to the target data source based on a smart contract according to usage attribute information of the target feature data.

According to another exemplary embodiment of the present disclosure, a blockchain-based outlet site selection apparatus can be provided. The apparatus can include a target feature dimension module, a target feature data module, a grid selection module and a token payment module.

The target feature dimension module can be configured to, in response to an outlet site selection request of a task demander, determine a target data source and a target feature dimension associated with the target data source.

The target feature data module can be configured to acquire, from the target data source, target feature data of candidate grids in a target region according to the target feature dimension and target region information in the outlet site selection request.

The grid selection module can be configured to select a target grid from the candidate grids according to the target feature data of the candidate grids.

The token payment module can be configured to control the task demander to pay a token to the target data source based on a smart contract according to usage attribute information of the target feature data.

According to another exemplary embodiment of the present disclosure, an electronic device can be provided. The electronic device includes at least one processor and a memory communicatively connected to the at least one processor.

The memory can store instructions executable by the at least one processor. The instructions, when executed by the at least one processor, can cause the at least one processor to execute the blockchain-based outlet site selection method according to any embodiment of the present disclosure.

According to another exemplary embodiment of the present disclosure, a non-transitory computer-readable storage medium storing computer instructions can be provided. The computer instructions can be configured to cause a computer to execute the blockchain-based outlet site selection method according to any embodiment of the present disclosure.

According to another exemplary embodiment of the present disclosure, a computer program product can be provided. The computer program product can include a computer program. The computer program, when executed by a processor, can cause the processor to perform the blockchain-based outlet site selection method according to any embodiment of the present disclosure.

According to various exemplary embodiments and/or technologies of the present disclosure, the efficiency of outlet site selection and the security of feature data can be improved.

It is to be understood that the content described in this part is neither intended to identify key or important features of embodiments of the present disclosure nor intended to limit the scope of the present disclosure. Other features of the present disclosure are apparent from the description provided hereinafter, e.g., when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is a flowchart of a blockchain-based outlet site selection method according to an exemplary embodiment of the present disclosure;

FIG. 2 is a flowchart of another blockchain-based outlet site selection method according to an exemplary embodiment of the present disclosure;

FIG. 3 is a flowchart of another blockchain-based outlet site selection method according to an exemplary embodiment of the present disclosure;

FIG. 4 is a diagram illustrating a blockchain-based outlet site selection apparatus according to an embodiment of the present disclosure; and

FIG. 5 is a block diagram of an electronic device for performing the blockchain-based outlet site selection method according to an embodiment of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

Exemplary embodiments of the present disclosure, including details of the exemplary embodiments of the present disclosure, are described hereinafter in conjunction with the drawings to facilitate understanding. The exemplary embodiments are merely illustrative. Therefore, it will be appreciated by those of ordinary skill in the art that various changes and modifications can be made to the embodiments described herein without departing from the scope and spirit of the present disclosure. Similarly, description of well-known functions and constructions is omitted hereinafter for clarity and conciseness.

The exemplary solution provided by the exemplary embodiments of the present disclosure is described in detail below in conjunction with the drawings.

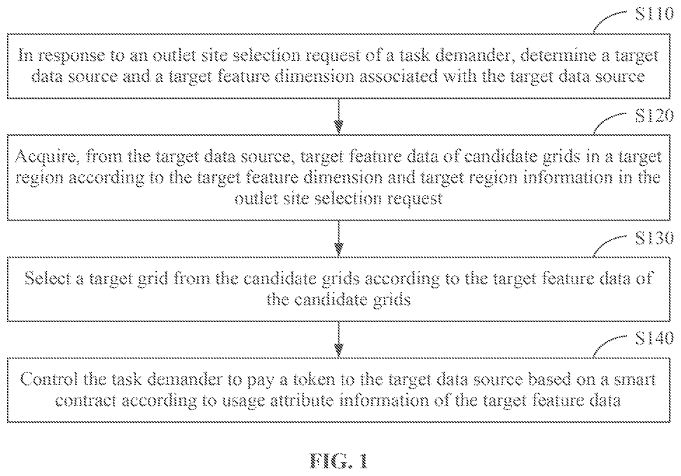

FIG. 1 shows a flowchart of a blockchain-based outlet site selection method according to an exemplary embodiment of the present disclosure. The exemplary embodiment of the present disclosure can be applicable to cases where outlet site selection is performed according to needs of a task demander. The exemplary method can be executable by a blockchain-based outlet site selection apparatus. The exemplary apparatus can be implemented in a form of hardware and/or software, and can be configured in an electronic device. FIG. 1 illustrates the exemplary steps and/or procedures of the exemplary embodiments of the method according to the present disclosure, which are described herein.

As provided in FIG. 1, exemplary step/procedure S110 indicates that, in response to an outlet site selection request of a task demander, a target data source and a target feature dimension associated with the target data source are determined.

In exemplary step/procedure S120, target feature data of candidate grids in a target region are acquired from the target data source according to the target feature dimension and target region information in the outlet site selection request.

In exemplary step/procedure S130, a target grid is selected from the candidate grids according to the target feature data of the candidate grids.

In exemplary step/procedure S140, the task demander is controlled to pay a token to the target data source based on a smart contract according to usage attribute information of the target feature data.

The task demander can refer to a business party having outlet site selection demands, such as banking business or communication operation business. The outlet site selection request can carry target region information. The target region refers to a region where the task demander needs to open a new outlet. The target region information can be identifications of the target region and the city type of the target region to which the target region belongs.

The candidate grids in the target region can be obtained by dividing the target region into grids according to grid restriction information. A target grid is selected from the candidate grids to serve as a site selection proposal for a new outlet. The grid restriction information can be acquired from the task demander, and grid restriction information includes grid shape information and grid size information. The grid shape information can include circular or rectangular, and the grid size information can include a fixed size or a size range, for example, 1 km×1 km, 2 km×2 km, or 1 km to 2 km.

The target data source can be configured to provide a value of the target feature dimension. The target feature dimension refers to feature factors that affect the outlet site selection in the target region, that is, the feature factors that affect whether a candidate grid is selected as the target grid. The value of the target feature dimension (that is, the target feature data) can be obtained by statistics of user identify information, user behavior data, attribute information of an actual outlet and the like in the candidate grids. The target data source and the target feature dimension are not limited in the exemplary embodiment(s) of the present disclosure. In terms of banking outlet site selection, for example, the target data source can be map applications, bank card management organizations, search engines, banking applications and the like. The target feature dimension associated with the map applications can include the number of subway stations, the number of bus stations, the number of schools, the number of parking spaces, traffic congestion indicator, income level ratio at all levels, age ratio at all levels, ratio of occupations, the number of permanent residents, the number of staff, whether there is a car and the like. The target feature dimension associated with the bank card management organizations can include actual outlet sites, banking types to which the actual outlets belong, the ratio of consumption level at all levels, the distribution of card holders in all banks. The target feature dimension associated with the search engines can include the ratio of financial interest preferences, where the financial interest preferences can be financial management, loan and stock. The target feature dimension associated with the banking applications can include the number of people who have installed their own applications, the number of customers whose salaries are issued by banks on behalf of them and the like.

The blockchain can record the target data source that the task demander needs to use, that is, the target feature dimension that the target data source can provide. For example, the blockchain can record the association relationship between the identity information of the task demander, the target feature dimension and the target data source. Specifically, according to the identity information of the task demander, the target feature dimension and the target data source can be acquired from the blockchain; according to the target region information and the grid restriction information, the candidate grids can be obtained by dividing the target region into grids; according to the target feature dimension and the target region information, the target feature data of the candidate grids are acquired from the target data source; according to the target feature data of the candidate grids, the values of outlet site selection indicators of the candidate grids are determined, and according to the values, the target grid is selected from the candidate grids.

The outlet site selection indicator is configured to measure the possibility of opening an outlet in a candidate grid. For example, the outlet site selection indicator can be the number of total customers, the number of daily new customers of wealth management business, the number of daily new customers of credit card service, the number of daily new customers of debit card service, the total daily average deposit or the daily average new deposit. Specifically, according to the indicator values of the outlet site selection indicator, the candidate grids can be sorted, and according to the sorting result, the target grid is selected. It is to be noted that the outlet site selection indicators can be associated with different target feature data, that is, the outlet site selection indicators can be associated with different target feature dimensions and/or different target data sources.

The smart contract includes the usage charging rules of the target feature data by the task demander, for example, the single usage fee of the target feature data by the task demander. Specifically, the task demander and the target data source may agree on the target feature dimension associated with the target data source, the target feature data provided by the target data source and the single usage fee of the target feature data; and the agreed content is fixed as an electronic contract, and the electronic contract is converted to a smart contract and uploaded to the blockchain network for storage. When necessary, judicial effect may also be enhanced by connecting to the internet court.

The usage attribute information can include usage type, usage count, usage time and the like. Specifically, the task demander is controlled to pay the token to the target data source based on the smart contract according to the usage attribute information of the target feature data. A token may also be called a bookkeeping voucher. It is to be noted that the task demander pays the token to the target data source according to the actual usage of the target feature data, so the token limits paid to target data sources are different due to different usage attribute information. With the configuration in which the target feature data of the candidate grids provided by the target data source are used by the task demander to select the target grid to serve as the outlet site selection proposal, and the smart contract is called to control the task demander to pay the token to the target data source according to the usage attribute information of the target feature data provided by the task demander to the target data source, the outlet site selection can be automatized, the efficiency of outlet site selection can be improved, and the number of offline transactions between the task demander and the target data source can be reduced by using the token as the data usage voucher, thereby simplifying the interaction between the task demander and the target data source and improving the flexibility of outlet site selection. Moreover, with the configuration in which the token is paid to use the target feature data, the usage of the target feature data can be supervised, thereby avoiding the abuse and conversion of the target feature data and improving the security of the target feature data.

In the technical solution provided by the embodiment of the present disclosure, with the configuration in which the target grid is selected from the candidate grids to serve as the outlet site selection proposal of the task demander by using the target feature data provided by the target data source, the efficiency of outlet site selection can be improved. Moreover, with the configuration in which the task demander pays the token to the target data source as the data usage voucher, the flexibility of outlet site selection and the security of target feature data can be improved.

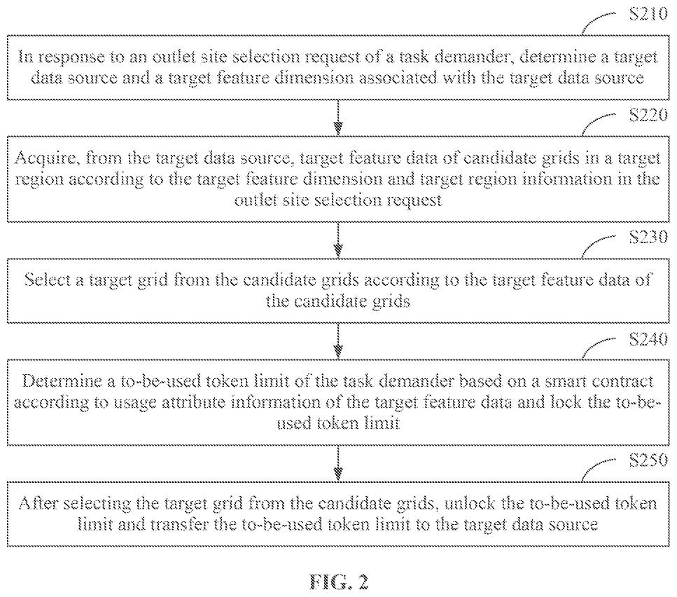

FIG. 2 shows a flowchart of another blockchain-based outlet site selection method according to an exemplary embodiment of the present disclosure. This exemplary method according to the exemplary embodiment of the present disclosure can facilitate a beneficial solution which can be provided based on the preceding embodiment.

As provided in FIG. 2, exemplary step/procedure S210 indicates that, in response to an outlet site selection request of a task demander, a target data source and a target feature dimension associated with the target data source can be determined.

In exemplary step/procedure S220, target feature data of candidate grids in a target region can be acquired from the target data source according to the target feature dimension and target region information in the outlet site selection request.

In exemplary step/procedure S230, a target grid can be selected from the candidate grids according to the target feature data of the candidate grids.

In exemplary step/procedure S240, a to-be-used token limit of the task demander can be determined and locked based on a smart contract according to usage attribute information of the target feature data.

In exemplary step/procedure S250, after the target grid is selected from the candidate grids, the to-be-used token limit can be unlocked and transferred to the target data source.

For example, the token limits to be paid to target data sources can be determined respectively and summarized based on the charging rules agreed in the smart contract according to usage attribute information of multiple target feature data to obtain the to-be-used token limit of the task demander, and according to the to-be-used token limit, the token in the account of the task demander can be locked.

Moreover, after the target grid is selected from the candidate grids, that is, after the task demander has successfully used the target feature data, the to-be-used token limit can be unlocked, and according to the usage of the multiple target feature data, the to-be-used token limit can be distributed to accounts of the target data sources. With the exemplary configuration in which the to-be-used token limit of the task demander is first locked, then unlocked after the task demander has successfully used the multiple target feature data, and distributed to the target data sources, a failure in token payment due to repeated usage of the token of the task demander can be avoided so that the rights of the target data source can be protected.

In another exemplary embodiment of the present disclosure, after the to-be-used token limit is locked, the exemplary steps/procedures also include that in a case where any target source resource refuses to provide the target feature data, the to-be-used token limit can be unlocked and returned to the task demander.

In the exemplary outlet site selection process, if any target data source refuses to provide the target feature data, the target grid cannot be selected from the candidate grids due to the incomplete target feature data, that is, the outlet site selection task is failed, and the outlet site selection is ended. In this exemplary case, with the exemplary configuration in which the to-be-used token limit is unlocked, and the to-be-used token is returned to the account of the task demander, loss to the task demander caused by a task failure can be avoided so that the rights of the task demander can be protected.

In yet another exemplary embodiment of the present disclosure, before the task demander is controlled to pay the token to the target data source, the exemplary steps/procedures can also provide that a historical usage count of the target feature data is acquired from the blockchain and used as the usage attribute information of the target feature data according to the target data source, the target feature dimension and the target region information.

The exemplary blockchain can also record the historical usage record of the target feature data. The historical usage record can include the target data source to which the target feature data belong, the target feature dimension associated with the target feature data, the target region information, the task demander and the like.

For example, according to the target data source, the target feature dimension and the target region information of the target feature data in this usage process, the historical usage record of the target feature data can be acquired from the blockchain, and according to the historical usage record, the historical usage count of the target feature data by the task demander is determined. According to the charging rules agreed in the smart contract, such as fixed-charging rule per time or stepped-charging rule per time, the token limit to be paid to the target data source by the task demander is determined. With the exemplary configuration in which the historical usage count of the target feature data is acquired from the blockchain, the to-be-paid token limit can be determined according to the historical usage count, that is, according to the historical usage count of the target feature data, data usage fee is paid to the target data source, thereby improving the flexibility of data usage charging.

In the exemplary embodiment of the present disclosure, before the target feature data are used, the to-be-used token limit of the task demander is determined and locked; and after the target grid is selected, that is, after the target feature data are used, the to-be-used token limit can be transferred to the target data source so that the rights of the target data source can be protected. Moreover, such charging rules as fixed-charging per time or stepped-charging per time are also supported so that the flexibility of data usage charging can be improved.

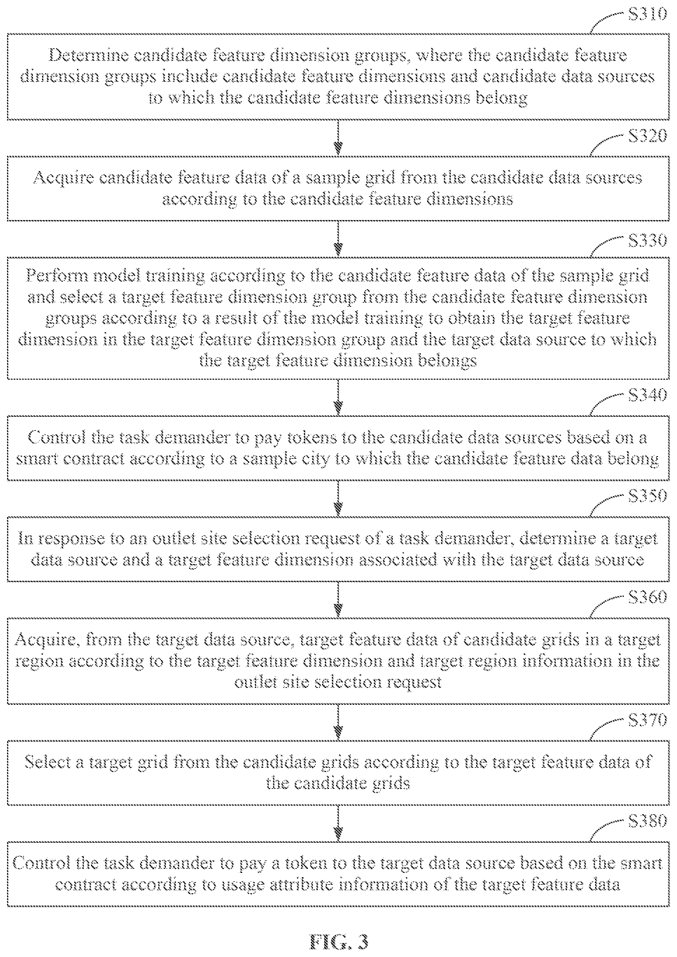

FIG. 3 shows a flowchart of another blockchain-based outlet site selection method according to an exemplary embodiment of the present disclosure. This exemplary embodiment facilitates an optional solution provided based on the exemplary embodiment described immediately herein above.

As provided in FIG. 3, exemplary step/procedure S310, candidate feature dimension groups can be determined, where the candidate feature dimension groups can include candidate feature dimensions and candidate data sources to which the candidate feature dimensions belong.

For example, the candidate feature dimension groups can be obtained by combination of the candidate data sources and the candidate feature dimensions that the candidate data sources can provide.

In exemplary step/procedure S320, candidate feature data of a sample grid can be acquired from the candidate data sources according to the candidate feature dimensions.

A sample grid can refer to a grid used in the target feature dimension selection stage, that is, a grid used in the model training stage. For example, with an actual outlet in the sample city as the center, according to the grid restriction information, the sample city can be divided into sample grids. It is to be noted that the grid restriction information used in the process of generating the candidate grids is the same as the grid restriction information used in the process of generating the sample grids.

For each candidate feature dimension group, e.g., according to the exemplary candidate feature dimensions in each candidate feature dimension group and the candidate data sources to which the candidate feature dimensions belong, the candidate feature data of the sample grid can be acquired from the candidate data sources. Moreover, according to exemplary attribute information of the actual outlet in the sample grid, tag values of outlet site selection indicators of the sample grid can be determined.

In exemplary step/procedure S330, model training can be performed according to the candidate feature data of the sample grid, and a target feature dimension group is selected from the candidate feature dimension groups according to an exemplary result of the model training to obtain the target feature dimension in the target feature dimension group and the target data source to which the target feature dimension belongs.

For example, the candidate feature data of the sample grid may serve as the input of a to-be-trained model, the tag values of the outlet site selection indicators of the sample grid may serve as the output of the to-be-trained model, and the model training is performed to obtain a candidate outlet site selection model. It is to be noted that for the candidate feature dimension groups, model trainings can be performed respectively to obtain candidate outlet site selection models.

The candidate outlet site selection models can be detected, a target outlet site selection model is selected from the candidate outlet site selection models according to a detection result, and the candidate feature dimension group associated with the target outlet site selection model serves as the target feature dimension group to obtain the target feature dimension and the target data source to which the target feature dimension belongs. The target outlet site selection model, the target feature dimension and the target data source are used for subsequent outlet prediction. For example, the association relationship between the task demander, the target feature dimension and the target data source can be written into the blockchain and used for the subsequent outlet site selection by directly using the target feature data.

In exemplary step/procedure S340, the task demander can be controlled to pay tokens to the candidate data sources based on a smart contract according to a sample city to which the candidate feature data belong.

The smart contract can include the usage charging rules of the candidate feature data by the task demander in the model training stage. The usage charging rules in the model prediction stage are not limited in the embodiment of the present disclosure. Since the candidate feature data can frequently be used in the model training stage, and trainings can be carried out for sample cities of different city types respectively in the model training stage, that is, the usage of the candidate feature data presents a characteristic of concentration in city types, charging can be packaged according to the sample city to which the candidate feature data belong. For example, charging amounts of sample cities of different city types can be different.

For example, after the candidate outlet site selection model trainings are finished, the sample city to which the candidate feature data belong used in the candidate outlet site selection model training processes can be acquired, and the tokens are paid to the candidate data sources according to sample procedures.

In the exemplary model training stage, the configuration in which the task demander is controlled to pay the tokens to the candidate data sources according to the sample city to which the candidate feature data belong is suitable for the following characteristics of the candidate feature data used in the model training stage: the frequent and complex usage and the concentration in a city. In this manner, the data usage charging method in the model prediction stage can be simplified.

In exemplary step/procedure S350, in response to an outlet site selection request of a task demander, a target data source and a target feature dimension associated with the target data source can be determined.

In exemplary step/procedure S360, target feature data of candidate grids in a target region can be acquired from the target data source according to the target feature dimension and target region information in the outlet site selection request.

In exemplary step/procedure S370, a target grid can be selected from the candidate grids according to the target feature data of the candidate grids.

For example, the target feature data of the candidate grids can serve as the input of the target outlet site selection model, the outlet site selection probability of the candidate grids are obtained according to the output of the target outlet site selection model, and the target grid is selected according to the outlet site selection probability of the candidate grids.

In exemplary step/procedure S380, the task demander can be controlled to pay a token to the target data source based on the smart contract according to usage attribute information of the target feature data.

Before the candidate data sources provide the candidate feature data, and the target feature source provides the target feature data, data usage authority of the task demander can also be approved. Feature data can be provided only when the approval is granted while the feature data are not provided when the approval is not granted. Moreover, the task approval information can be uploaded into the blockchain for record, such as data usage application reasons, required data content, approver, approval result, approval date, data provision date, data hash feature and the like.

In an exemplary embodiment of the present disclosure, the exemplary steps/procedures can also include that a contribution of a data source is determined according to a held token limit.

The contribution of the data source can be positively associated with the held token limit. In the embodiment of the present disclosure, according to token limits held by the data sources, that is, the candidate data sources and the target data source, the contributions of the data sources can be determined respectively. For example, the data sources can obtain corresponding remunerations according to the token limits held by the data sources.

In the exemplary blockchain network, roles of participants can be changed to each other, and a participant as a data source can be changed to a task demander. For example, not only do the bank applications need to acquire the traveling data of the population feature from the map applications, but the map applications also need to acquire the asset data of the population feature from the bank applications. The contributions of participants to the blockchain network in the blockchain network-based distributed computing network can be well measured by use of the token limits held by the data sources. Moreover, the usage of sensitive data can be subject to tamper-proof compliance auditing. The income can be fairly distributed to the participants in the blockchain network by use of the token as the bookkeeping voucher to measure the contributions so that the efficiency and the reliability of income distribution can also be improved.

In the exemplary technical solution according to the exemplary embodiment of the present disclosure, in the model training stage and the outlet prediction stage, the task demander pays the tokens to the data sources according to the feature data provided by the data sources, and the contributions of different data sources in the blockchain network can be measured by use of the tokens.

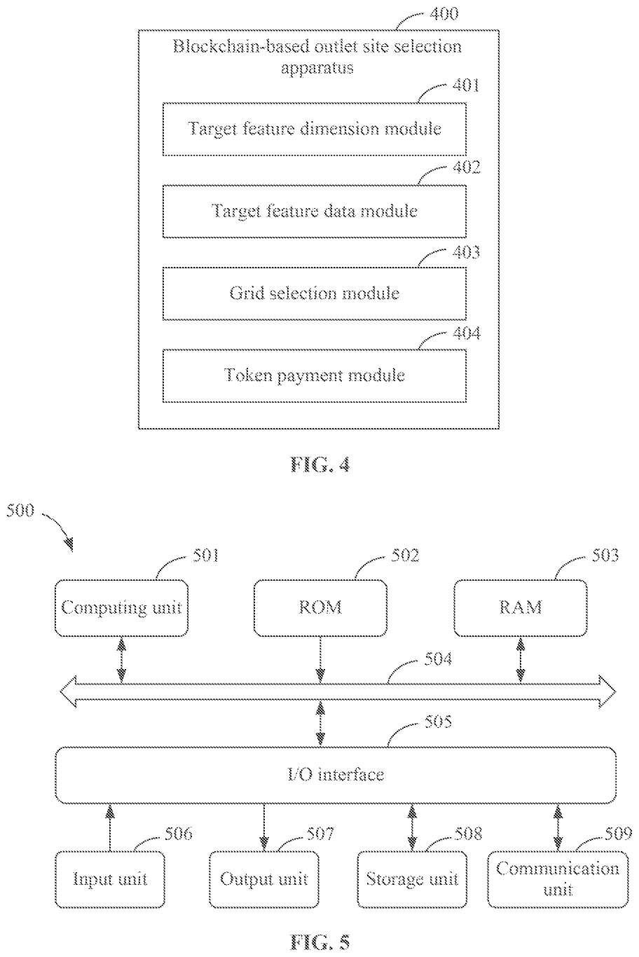

FIG. 4 shows a diagram illustrating an exemplary blockchain-based outlet site selection apparatus according to an exemplary embodiment of the present disclosure. The exemplary embodiment can be applicable to cases where outlet site selection is performed according to needs of the task demander. The apparatus is configured in an electronic device and can perform the blockchain-based outlet site selection method described in any embodiment of the present disclosure. Referring to FIG. 4, the blockchain-based outlet site selection apparatus 400 can include a target feature dimension module 401, a target feature data module 402, a grid selection module 403 and a token payment module 404.

The target feature dimension module 401 can be configured to, in response to an outlet site selection request of a task demander, determine a target data source and a target feature dimension associated with the target data source.

The target feature data module 402 can be configured to, from the target data source, acquire target feature data of candidate grids in a target region according to the target feature dimension and target region information in the outlet site selection request.

The grid selection module 403 can be configured to select a target grid from the candidate grids according to the target feature data of the candidate grids.

The token payment module 404 can be configured to control the task demander to pay a token to the target data source based on a smart contract according to usage attribute information of the target feature data.

In an exemplary embodiment of the present disclosure, the token payment module 404 can include a token lock unit and a token transfer unit.

The token lock unit can be configured to determine a to-be-used token limit of the task demander based on the smart contract according to the usage attribute information of the target feature data and lock the to-be-used token limit.

The token transfer unit can be configured to, after the target grid is selected from the candidate grids, unlock the to-be-used token limit and transfer the to-be-used token limit to the target data source.

In an exemplary embodiment of the present disclosure, the token payment module 404 can further include a token return unit.

The token return unit can be configured to, in a case where any target data source refuses to provide the target feature data, unlock the to-be-used token limit and return the to-be-used token limit to the task demander.

In an exemplary embodiment of the present disclosure, the blockchain-based outlet site selection apparatus 400 can further include a usage attribute determination module.

The usage attribute determination module can be configured to acquire a historical usage count of the target feature data from a blockchain according to the target data source, the target feature dimension and the target region information and use the historical usage count as the usage attribute information of the target feature data.

In an exemplary embodiment of the present disclosure, the blockchain-based outlet site selection apparatus 400 can further include a model training module. The model training module can include a candidate feature dimension unit, a candidate feature data unit, a model training unit and a token payment unit.

The candidate feature dimension unit can be configured to determine candidate feature dimension groups, where the candidate feature dimension groups can include candidate feature dimensions and candidate data sources to which the candidate feature dimensions belong.

The candidate feature data unit can be configured to acquire candidate feature data of a sample grid from the candidate data sources according to the candidate feature dimensions.

The model training unit can be configured to perform model training according to the candidate feature data of the sample grid and select a target feature dimension group from the candidate feature dimension groups according to a result of the model training to obtain the target feature dimension in the target feature dimension group and the target data source to which the target feature dimension belongs.

The token payment unit can be configured to control the task demander to pay tokens to the candidate data sources based on the smart contract according to a sample city to which the candidate feature data belong.

In an exemplary embodiment of the present disclosure, the blockchain-based outlet site selection apparatus 400 can further include a contribution module.

The contribution module can be configured to determine a contribution of a data source according to a held token limit.

In the exemplary technical solution according to the exemplary embodiment of the present disclosure, the task demander can pay the tokens to the data sources according to the feature data provided by the data sources, and the contributions of different data sources in the blockchain network can be measured by use of the tokens.

In the exemplary technical solutions in the present disclosure, acquisition, storage and application of user personal information involved can be in compliance with relevant laws and regulations and do not violate the public order and good customs.

According to the exemplary embodiments of the present disclosure, an electronic device, a readable storage medium and a computer program product can be provided.

FIG. 5 shows a block diagram of an exemplary electronic device 500 that can be configured to perform the exemplary embodiments of the present disclosure. Exemplary electronic devices are intended to represent various forms of digital computers, for example, laptop computers, desktop computers, worktables, personal digital assistants, servers, blade servers, mainframe computers and other applicable computers. Electronic devices can further represent various forms of mobile apparatuses, for example, personal digital assistants, cellphones, smartphones, wearable devices and other similar computing apparatuses. Various exemplary components, connections and relationships between these components/elements, and the functions of these components shown in FIG. 5 are exemplary only and are not intended to limit the implementation of the present disclosure as described and/or claimed herein.

As shown in FIG. 5, the device 500 can include a computing unit 501. The computing unit 501 can perform various types of appropriate operations and processing based on a computer program stored in a read-only memory (ROM) 502 or a computer program loaded from a storage unit 508 to a random-access memory (RAM) 503. Various programs and data required for operations of the device 500 can also be stored in the RAM 503. The computing unit 501, the ROM 502 and the RAM 503 can be connected to each other by a bus 504. An input/output (I/O) interface 505 can also be connected to the bus 504.

Multiple exemplary components in the device 500 can be connected to the I/O interface 505. The multiple components can include an input unit 506 (such as, e.g., a keyboard and a mouse), an output unit 507 (such as, e.g., various types of displays and speakers), the storage unit 508 (such as, e.g., a magnetic disk and an optical disk), and a communication unit 509 (such as, e.g., a network card, a modem or a wireless communication transceiver). The communication unit 509 can facilitate the device 500 to exchange information/data with other devices over a computer network such as the Internet and/or various telecommunications networks.

The computing unit 501 can be and/or include various general-purpose and/or special-purpose processing components having processing and computing capabilities. Examples of the computing unit 501 can include, but are not limited to, a central processing unit (CPU), a graphics processing unit (GPU), a special-purpose artificial intelligence (AI) computing chip, a computing unit executing machine learning model algorithms, a digital signal processor (DSP) and any appropriate processor, controller and microcontroller. The computing unit 501 can execute various preceding methods and processing, such as the blockchain-based outlet site selection method. For example, in some exemplary embodiments of the present disclosure, the blockchain-based outlet site selection method can be implemented as a computer software program tangibly contained in a machine-readable medium such as the storage unit 508. In some exemplary embodiments, part or all of the computer program can be loaded and/or installed on the device 500 via the ROM 502 and/or the communication unit 509. When the computer program is loaded to the RAM 503 and executed by the computing unit 501, one or more exemplary steps/procedures of the preceding exemplary blockchain-based outlet site selection method can be executed. Alternatively, in other exemplary embodiments, the computing unit 501 can be configured, in any other suitable manner (for example, via firmware), to execute the exemplary blockchain-based outlet site selection method.

Herein various exemplary embodiments of the systems and techniques described in the preceding can be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software and/or combinations thereof. The various embodiments can include implementations in one or more computer programs. Such one or more computer programs can be executable and/or interpretable on a programmable system including at least one programmable processor. Such programmable processor(s) can be or include a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for implementing the methods according to the exemplary embodiments of the present disclosure can be compiled in any combination of one or more programming languages. The program codes can be provided for the processor or controller of a general-purpose computer, a special-purpose computer or another programmable data processing apparatus to enable functions/operations specified in flowcharts and/or block diagrams to be implemented when the program codes are executed by the processor or controller. The program codes can be executed in whole on a machine, executed in part on a machine, executed, as a stand-alone software package, in part on a machine and in part on a remote machine, or executed in whole on a remote machine or a server.

In the context of the exemplary embodiments of the present disclosure, a machine-readable medium can be a tangible medium that can include or store a program that is used by or in conjunction with a system, apparatus or device that executes instructions. The machine-readable medium can be a machine-readable signal medium or a machine-readable storage medium. The machine-readable medium can include, but is not limited to, electronic, magnetic, optical, electromagnetic, infrared or semiconductor systems, devices or equipment or any suitable combinations thereof. Concrete examples of the machine-readable storage medium can include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein can be implemented on one or more computers. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses can also be used for providing interaction with a user. For example, feedback provided for the user can be sensory feedback in any form (for example, visual feedback, auditory feedback or haptic feedback). Moreover, input from the user can be received in any form (including acoustic input, voice input or haptic input).

The exemplary embodiments of the systems and techniques described herein can be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of an exemplary system can be interconnected by any form or medium of digital data communication (for example, a communication network). Examples of the communication network include a local area network (LAN), a wide area network (WAN), a blockchain outlet and the Internet.

The exemplary computing system can include clients and servers. The clients and servers are usually far away from each other and generally interact through the communication network. The relationship between the client and the server arises by virtue of computer programs running on respective computers and having a client-server relationship to each other. The server can be a cloud server, also referred to as a cloud computing server or a cloud host. As a host product in a cloud computing service system, the server solves the defects of difficult management and weak service scalability in a related physical host and a related VPS service.

It is to be understood that various forms of the preceding flows can be used, with steps/procedures reordered, added or removed. For example, the steps/procedures described in the exemplary embodiments of the present disclosure can be executed in parallel, in sequence or in a different order as long as the desired result of the technical solutions disclosed in the present disclosure is achieved. The execution sequence of these exemplary steps/procedures is not limited herein.

The scope of the present disclosure is not limited to the preceding exemplary embodiments. It is to be understood by those skilled in the art that various modifications, combinations, sub-combinations and substitutions can be made depending on design requirements and other factors. Any modifications, equivalent substitutions, improvements and the like made within the spirit and principle of the present disclosure fall within the scope of the present disclosure.

What is claimed is:

1. A blockchain-based outlet site selection method, comprising:
in response to an outlet site selection request of a task demander, determining a target data source and a target feature dimension associated with the target data source;
acquiring, from the target data source, target feature data of candidate grids in a target region according to the target feature dimension and target region information in the outlet site selection request;
selecting a target grid from the candidate grids according to the target feature data of the candidate grids; and
controlling the task demander to pay a token to the target data source based on a smart contract according to usage attribute information of the target feature data.

2. The method according to claim 1, wherein the controlling the task demander to pay the token to the target data source based on the smart contract according to the usage attribute information of the target feature data comprises:
determining a to-be-used token limit of the task demander based on the smart contract according to the usage attribute information of the target feature data and locking the to-be-used token limit; and
after selecting the target grid from the candidate grids, unlocking the to-be-used token limit and transferring the to-be-used token limit to the target data source.

3. The method according to claim 2, wherein before the controlling the task demander to pay the token to the target data source, the method further comprises:
acquiring a historical usage count of the target feature data from a blockchain according to the target data source, the target feature dimension and the target region information and using the historical usage count as the usage attribute information of the target feature data.

4. The method according to claim 3, further comprising:
before the controlling the task demander to pay the token to the target data source, acquiring a historical usage count of the target feature data from a blockchain according to the target data source, the target feature dimension and the target region information and using the historical usage count as the usage attribute information of the target feature data.

5. The method according to claim 2, wherein after the locking the to-be-used token limit, the method further comprises:
in a case where the target data source refuses to provide the target feature data, unlocking the to-be-used token limit and returning the to-be-used token limit to the task demander.

6. The method according to claim 1, wherein before the controlling the task demander to pay the token to the target data source, the method further comprises:
acquiring a historical usage count of the target feature data from a blockchain according to the target data source, the target feature dimension and the target region information and using the historical usage count as the usage attribute information of the target feature data.

7. The method according to claim 1, wherein, before responding to the outlet site selection request of the task demander, performing procedures comprising:
determining candidate feature dimension groups, and wherein the candidate feature dimension groups comprise candidate feature dimensions and candidate data sources to which the candidate feature dimensions belong;
acquiring candidate feature data of a sample grid from the candidate data sources according to the candidate feature dimensions;
performing model training according to the candidate feature data of the sample grid and selecting a target feature dimension group from the candidate feature dimension groups according to a result of the model training to obtain the target feature dimension in the target feature dimension group and the target data source to which the target feature dimension belongs; and
controlling the task demander to pay tokens to the candidate data sources based on the smart contract according to a sample city to which the candidate feature data belong.

8. The method according to claim 1, further comprising:
determining a contribution of a data source according to a held token limit.

9. An electronic device, comprising:
at least one processor and
an electronic memory communicatively connected to the at least one processor,
wherein the electronic memory stores instructions executable by the at least one processor, wherein the instructions, when executed by the at least one processor, cause the at least one processor to perform procedures comprising:
in response to an outlet site selection request of a task demander, determine a target data source and a target feature dimension associated with the target data source;
acquire, from the target data source, target feature data of candidate grids in a target region according to the target feature dimension and target region information in the outlet site selection request;
select a target grid from the candidate grids according to the target feature data of the candidate grids; and
control the task demander to pay a token to the target data source based on a smart contract according to usage attribute information of the target feature data.

10. The electronic device according to claim 9, wherein the controlling the task demander to pay the token to the target data source based on the smart contract according to the usage attribute information of the target feature data comprises:
determining a to-be-used token limit of the task demander based on the smart contract according to the usage attribute information of the target feature data and locking the to-be-used token limit; and
after selecting the target grid from the candidate grids, unlocking the to-be-used token limit and transferring the to-be-used token limit to the target data source.

11. The electronic device according to claim 10, wherein the at least one processor is further configured to, after the locking the to-be-used token limit and in a case where the target data source refuses to provide the target feature data, unlock the to-be-used token limit and returning the to-be-used token limit to the task demander.

12. The electronic device according to claim 11, wherein the at least one processor is further configured to, before the controlling the task demander to pay the token to the target data source, acquire a historical usage count of the target feature data from a blockchain according to the target data source, the target feature dimension and the target region information and using the historical usage count as the usage attribute information of the target feature data.

13. The electronic device according to claim 10, wherein the at least one processor is further configured to, before the controlling the task demander to pay the token to the target data source, acquire a historical usage count of the target feature data from a blockchain according to the target data source, the target feature dimension and the target region information and using the historical usage count as the usage attribute information of the target feature data.

12. The electronic device according to claim 9, wherein the at least one processor is further configured to, before responding to the outlet site selection request of the task demander, acquire a historical usage count of the target feature data from a blockchain according to the target data source, the target feature dimension and the target region information and using the historical usage count as the usage attribute information of the target feature data.

15. The electronic device according to claim 9, wherein the at least one processor, before responding to the outlet site selection request of the task demander, is further configured to:
determine candidate feature dimension groups, wherein the candidate feature dimension groups comprise candidate feature dimensions and candidate data sources to which the candidate feature dimensions belong;
acquire candidate feature data of a sample grid from the candidate data sources according to the candidate feature dimensions;
perform model training according to the candidate feature data of the sample grid and selecting a target feature dimension group from the candidate feature dimension groups according to a result of the model training to obtain the target feature dimension in the target feature dimension group and the target data source to which the target feature dimension belongs; and
control the task demander to pay tokens to the candidate data sources based on the smart contract according to a sample city to which the candidate feature data belong.

16. The electronic device according to claim 9, wherein the at least one processor is further configured to determine a contribution of a data source according to a held token limit.

17. A non-transitory computer-readable storage medium storing computer instructions, wherein the computer instructions, when executed on one or more computer, configure the one or more computer to execute procedures comprising:
in response to an outlet site selection request of a task demander, determining a target data source and a target feature dimension associated with the target data source;
acquiring, from the target data source, target feature data of candidate grids in a target region according to the target feature dimension and target region information in the outlet site selection request;
selecting a target grid from the candidate grids according to the target feature data of the candidate grids; and
controlling the task demander to pay a token to the target data source based on a smart contract according to usage attribute information of the target feature data.

18. The non-transitory computer-readable storage medium according to claim 17, wherein the controlling procedure comprises:
determining a to-be-used token limit of the task demander based on the smart contract according to the usage attribute information of the target feature data and locking the to-be-used token limit; and
after selecting the target grid from the candidate grids, unlocking the to-be-used token limit and transferring the to-be-used token limit to the target data source.

19. The non-transitory computer-readable storage medium according to claim 18, wherein the at least one computer is further configured to, after the locking the to-be-used token limit and when the target data source refuses to provide the target feature data, unlock the to-be-used token limit and returning the to-be-used token limit to the task demander.

20. The non-transitory computer-readable storage medium according to claim 17, wherein the at least one computer is further configured to, the controlling the task demander to pay the token to the target data source, acquire a historical usage count of the target feature data from a blockchain according to the target data source, the target feature dimension and the target region information and using the historical usage count as the usage attribute information of the target feature data.
